(19) United States
(12) Patent Application Publication
(10) Pub. No.: US 2023/0016911 A1
(43) Pub. Date: Jan. 19, 2023

(54) WINDSHIELD SUB-ASSEMBLY FOR A BOAT

(71) Applicant: PRELCO Inc., Rivière-du-loup (CA)

(72) Inventor: Simon DUBE, Quebec (CA)

(21) Appl. No.: 17/865,204

(22) Filed: Jul. 14, 2022

Related U.S. Application Data
(60) Provisional application No. 63/222,313, filed on Jul. 15, 2021.

(51) Int. Cl. B29C 33/42; B63B 19/02; B33Y 80/00; B29C 65/48; B29C 65/00; B29C 39/02; B29C 39/26

(52) U.S. Cl. CPC B29C 33/42; B29C 39/02; B29C 39/26; B29C 65/48; B29C 66/7465; B33Y 80/00; B63B 19/02; B29K 2709/08

(57) ABSTRACT

A method for manufacturing a boat windshield comprising providing a piece of glass of an arbitrary shape to form a portion of a boat windshield; and providing a mold or cast defining a cavity for molding or casting an appropriate material therein. The cavity defines a shape of a frame to be molded or cast and having a shape complementary to a contour of the corresponding piece of glass having the arbitrary shape, said frame having otherwise an arbitrary frame shape including variable cross-section, width or thickness along a length thereof; or it can longitudinally extend in a curved manner. After molding or casting said frame (alternatively: additive manufacturing), together with functional features, said frame is secured to the corresponding piece of glass or encapsulating the corresponding piece of glass into said frame having been molded or cast, forming a sub-frame assembly being a panel of the boat windshield.

### RELATED APPLICATION

The present patent application claims priority to, or benefit from, U.S. Provisional Pat. Application No. 63/222,313, filed Jul. 15, 2021, the disclosure of which is incorporated herein by reference in its entirety.

### FIELD OF THE INVENTION

The subject matter disclosed generally relates to boat windshields. More specifically, it relates to a framing system for boat windshields.

### BACKGROUND

Boat windshields are mounted in the boat with a frame typically made of extrusions, for example extruded aluminum or stainless-steel parts. Gaskets may then be applied on the piece of glass and the extruded parts are used to form a rail to receive the piece of glass in view of mounting this assembly onto a boat.

Alternatively, the extruded parts can be assembled together to form a hidden frame which is glued to a piece of glass to hold it within the frame and mounting this assembly onto a boat.

### SUMMARY

According to an aspect of the disclosure, there is provided a method for manufacturing a boat windshield comprising the steps of:
providing a piece of glass of an arbitrary shape to form a portion of a boat windshield;
providing a mold or cast defining a cavity for molding or casting an appropriate material therein, said cavity defining a shape of a frame to be molded or cast and having a shape complementary to a contour of the corresponding piece of glass having the arbitrary shape, said frame having otherwise an arbitrary frame shape;
molding or casting said frame with the mold or cast; and
securing said frame to the corresponding piece of glass by using an adhesive or by encapsulating the corresponding piece of glass into said frame having been molded or cast, forming a sub-frame assembly being a panel of the boat windshield.

According to an embodiment, the method comprises including, to the mold or cast defining the cavity, functional features directly and integrally with the frame to be molded.

According to an embodiment, including, to the mold or cast defining the cavity, functional features directly and integrally with the frame to be molded comprises, when forming a frame extending at least locally in a plane or an elongation axis and, forming the functional feature as a protrusion which extends away from the plane or the elongation axis of the frame.

According to an embodiment, the protrusion is a flange integral with the frame for mounting the frame onto a boat.

According to an embodiment, the functional features included directly and integrally with the frame to be molded comprise parts of a mounting system, the method further comprising directly mounting the sub-frame assembly onto a boat using the parts of the mounting system which are integrally molded or cast as an integral part of the frame of the sub-frame assembly. According to an embodiment, there is provided a boat windshield made by this method.

According to an embodiment, forming the functional features comprises forming a bore integral with a remainder of the frame at the time of forming the frame.

According to an embodiment, including, to the mold or cast defining the cavity, functional features directly and integrally with the frame to be molded, comprises forming said functional features together with the frame being formed without altering the frame after the frame is formed to form said functional features.

According to an embodiment, the frame and the functional features are formed together only by molding or casting.

According to an embodiment, the frame is formed only by molding or casting.

According to an embodiment, molding or casting said frame comprises forming the frame having at least a part thereof extending longitudinally along a length thereof, a cross-section being variable in at least one of shape and size along the length thereof.

According to an embodiment, molding or casting said frame comprises forming the frame having at least a part thereof extending longitudinally along a longitudinal axis which is curved along a length thereof.

According to an embodiment, molding or casting said frame comprises forming the frame having at least a part thereof extending along a plane, a thickness being variable along the plane.

According to another aspect of the disclosure, there is provided a method for manufacturing a boat windshield comprising the steps of:
providing a piece of glass of an arbitrary shape to form a portion of a boat windshield;
3D-printing, or more generally, using additive manufacturing to produce a frame having a shape complementary to a contour of the corresponding piece of glass having the arbitrary shape, said frame having otherwise an arbitrary frame shape;
securing said frame to the corresponding piece of glass by using an adhesive or by encapsulating the corresponding piece of glass into said frame having been 3D-printed, forming a sub-frame assembly being a panel of the boat windshield.

According to an embodiment, using additive manufacturing or more specifically 3D-printing the frame comprises 3D-printing functional features directly and integrally with the frame being 3D-printed.

According to an embodiment, using additive manufacturing or more specifically 3D-printing functional features directly and integrally with the frame being 3D-printed comprises, when forming a frame extending at least locally in a plane or an elongation axis and, forming the functional feature as a protrusion which extends away from the plane or the elongation axis of the frame.

According to an embodiment, the functional features included directly and integrally with the frame comprise parts of a mounting system, the method further comprising directly mounting the sub-frame assembly onto a boat using the parts of the mounting system which are integrally 3D-printed (or fabricated using additive manufacturing) as an integral part of the frame of the sub -frame assembly.

According to an embodiment, the frame and the functional features are formed together only by 3D-printing (or more generally: additive manufacturing).

According to an embodiment, molding or casting said frame comprises forming the frame having at least a part thereof extending longitudinally along a length thereof, a cross-section being variable in at least one of shape and size along the length thereof.

According to another aspect, there is provided a sub-frame assembly made by the method such as listed above.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Further features and advantages of the present disclosure will become apparent from the following detailed description, taken in combination with the appended drawings, in which:

FIG. 1 is a front view illustrating a door of a boat windshield, according to the prior art;

FIG. 2 is a front view illustrating a door of a boat windshield in a sub -assembly, according to an embodiment;

FIG. 3 is a close-up view illustrating a mounting system for a door of a boat windshield, according to the prior art;

FIG. 4 is a close-up view illustrating a mounting system for a door of a boat windshield which is made in a sub-frame for the door, according to an embodiment;

FIG. 5 is a front view illustrating a door of a boat windshield, according to the prior art;

FIG. 6 is a front view illustrating a door of a boat windshield encapsulated in a sub-frame, according to an embodiment;

FIG. 7 is a front perspective view illustrating a boat windshield with the molded or cast frame portions, according to an embodiment;

FIG. 8 is a rear perspective view illustrating a boat windshield with the molded or cast frame portions, according to an embodiment;

FIG. 9 is a rear view illustrating (with transparency) a door of a boat windshield with the molded or cast frame portions, according to an embodiment;

FIGS. 10-13 are rear views illustrating a door of a boat windshield with the molded or cast frame portions, with bottom, up, port and starboard portions highlighted, respectfully, according to an embodiment; and

FIG. 14 is a flowchart illustrating a method for manufacturing a portion (window, door) of a boat windshield, according to an embodiment of the invention.

It will be noted that throughout the appended drawings, like features are identified by like reference numerals.

### DETAILED DESCRIPTION

One of the main requirements for boat windows is to ensure protection to provide and visibility on the surroundings which is as good as possible. Demands on the functionality and design of the windows are continually increasing but limited by the industry-wide use of the current framing system, which comprises a mix of extrusion, casting, and injection plastic parts.

Current customer tastes dictate the need to be able to provide complex shapes for boat windows. Also, ensuring easy windshield assembly for the boat windshield, easy installation and easy operation are great advantages that framing system should provide.

Also, additional functions are increasingly being incorporated into windows or over them, such as mirror bracket, speakers, and other functional or decorative elements.

The current framing system widely used in the industry involve multiple component (extrusion, casting, injection plastic parts) framed individually on the window.

There is now proposed, as herein described, an encapsulation of the glass into a subframe mainly manufactured from casting, such as die casting, permanent mold casting, sand casting or injection molded plastic. Glass encapsulation may then take place in a cast or molded material, instead of in an extrusion.

According to an embodiment of the disclosure, this new subassembly should be mountable on a boat deck and withstand all the same functionalities over time as the current framing system does.

The new framing system in which the glass is encapsulated in a subframe, forming a subassembly, should reduce the size of the frame itself (the effective width of the contour of the frame around the glass) to improve overall driver visibility.

The use of molding or casting ensures that when multiple iterations of the frame are made, the cost per unit becomes lower and cost-effectiveness is achievable. It means that the current multiple framing system with extruded portions and multiple components can be replaced with the frame assembly according to an embodiment in which the sub-frame forming a single unit to be handled greatly facilities handling and installation of the sub-assembly comprising said sub-frame onto a boat deck. The mounting system for removable doors can also be redesigned with greater liberty in comparison with current, extrusion -containing frames of the current industry standard.

Having a cast or molded frame also gives more possibilities or freedom in terms if inside view design.

Using a cast or molded frame is much more precise than an assembly of various parts together, including extrusions, as in the prior art. Having a single part manufactured with very high accuracy allows the cast or molded single part to be referenced in a CNC, according to an embodiment, which further enhances flexibility in design and allows personalization of the part, again with a very high accuracy. For example, in can mean that the mounting elements of a hingeable door of the boat windshield can be made as an integrated feature within said single-part frame using CNC machining (CNC: computer numerical control).

In a typical boat windshield, the windshield is manufactured using multiple pieces of glass, since the windshield comprises different glass portions, i.e., different windows in different orientations or having different shapes, and a door. According to an embodiment, each single piece of glass, each corresponding to one window or one door, or one portion thereof, is individually mounted into a corresponding subframe which only comprises such a single piece of glass. Each subframe would then be assembled together to build the complete windshield. Alternatively, multiple pieces of glass can also be framed into one subframe to build a windshield assembly.

According to an embodiment, the cast or molded frame is a single piece. It is made as a single piece by casting or molding and replaces the multicomponent frame of the prior art.

For greater clarity, forming a single-piece in an integral manner, by casting or molding, also means that there is no welding or soldering, in that the single-piece is formed as a single-piece without having to resort to other forms of permanent attachment such as welding or soldering. The single-part frame is therefore formed only by molding or casting, or 3D printing (or more generally, additive manufacturing). If permanent attachments are required (e.g., the single-part frame can be permanently secured to the glass, for example), these permanently attached parts are not hereby considered to be integral one with the other. The single-part nature of the frame integrally formed as one relates to the frame being formed as a single-piece at the time of forming.

For example, and without limitation, the single-piece frame can be made by using: injection molding of a plastic material or an equivalent thereof, injection or die-casting of a metal (such as aluminum) or an equivalent thereof, permanent mold casting, permanent mold casting, sand casting, etc., using metallic materials to make-up the single-piece frame. According to another embodiment, stamping of the material can be used to form the single-piece frame. Any other way, to add a single-piece frame on a contour of a piece of glass can be contemplated. The piece of glass may then be encapsulated in the molded plastic frame or cast metal frame.

According to an embodiment, the cast or molded single piece forming the frame is secured to the piece of glass that corresponds thereto. According to an embodiment, the single-piece frame is secured permanently to the corresponding piece of glass. For example, and without limitation, it can be secured by an adhesive. Preferably, it can be glued to the inner face of the piece of glass to form a sub-frame assembly. It can also be encapsulated within the single-piece frame.

According to an embodiment, overmolding can also be contemplated by encapsulating the piece of glass in the corresponding single-part overmolded frame being made by overmolding on the suitable portions of the piece of glass.

According to an embodiment, 3D printing or additive manufacturing can be used to manufacture a part with a particular shape.

In contrast with prior art methods where a boat windshield is an assembly of aluminum extrusions, stainless-steel parts, and other parts, according to an embodiment, there would be no assembly of any heterogenous parts into a frame, as the frame or a significant portion thereof is formed by molding or casting.

Also, in contrast with prior art methods where the piece of glass has extruded parts glued thereto, the present method, according to an embodiment, relies on the encapsulation of the piece of glass with the molded or cast single-part sub-frame to form a sub-frame assembly with the piece of glass.

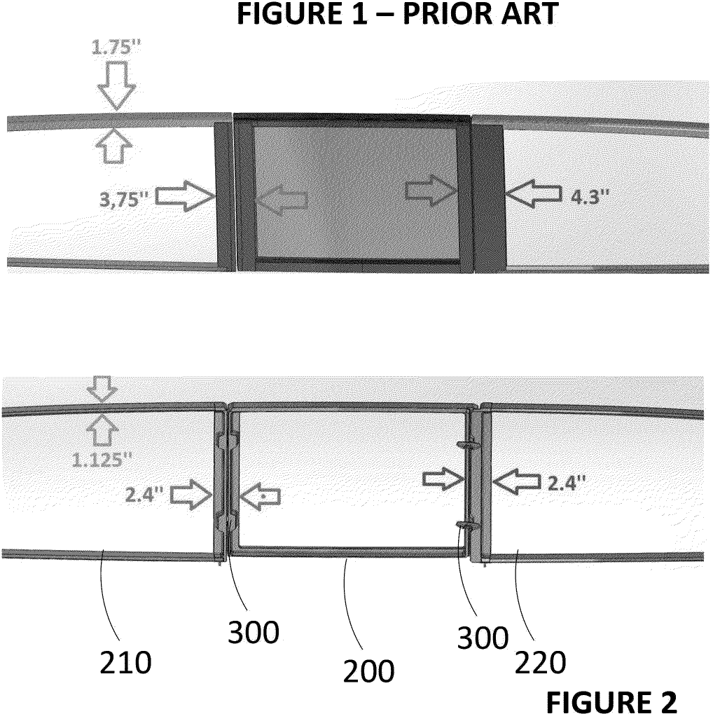

Referring now to FIG. 2, it is shown that the door would be sub-framed. According to an embodiment, the port hinge and/or starboard door flange is also sub-framed. The top header size is reduced, which allows for redesigns, as shown in comparison with the prior-art equivalent of FIG. 1. Each of the sub-frame assembly can thus be molded or cast to include, when molded or cast, particular features 300 which should be present. For example, when considering a door of the boat windshield, there is a hinge on one side (e.g., port side of the boat) and a flange which retains the door on the opposite side (e.g., starboard side). Therefore, either the door panel 200 and/or the appropriate immediately adjacent panel (210, 220), which are examples of a sub-frame assembly, can include, on the molded cast frame portion of such panel, such features 300 (hinge gear such as a bore, a flange, parts of the mounting system 310 for direct mounting in the boat, etc., directly fabricated integrally with the frame or within the frame together at the time of forming the frame and by altering the frame not afterwards).

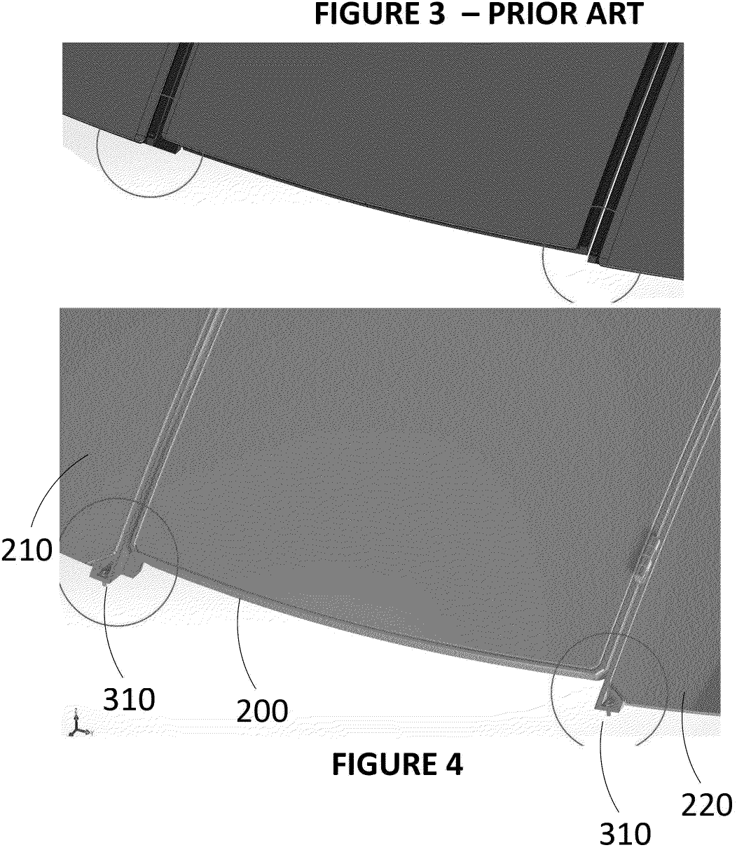

Referring now to FIG. 4, it is shown that the mounting system 310 according to an embodiment can be simplified and fully integrated into the subframe, as shown in comparison with the prior-art equivalent of FIG. 3. This is an example of the features 300 which can be integrally included to the frame when the mold or cast is defined. Having the mounting system 310 already integrally included within the frame of a panel of the windshield (i.e., a protrusion integral with a remainder of the frame with screw holes already formed through the protrusion already integrally included in the frame of the sub-frame assembly forming the panel) is advantageous as it removes a step of the manufacturing process to speed up the process and jump directly to the mounting of the sub -frame assembly onto the boat. As mentioned above, the terms “integral” or “integrally” exclude the a posteriori steps of welding or soldering; “integral” or "integrally’ mean built as one piece at the time of forming (by molding, casting, session of additive manufacturing, etc.).

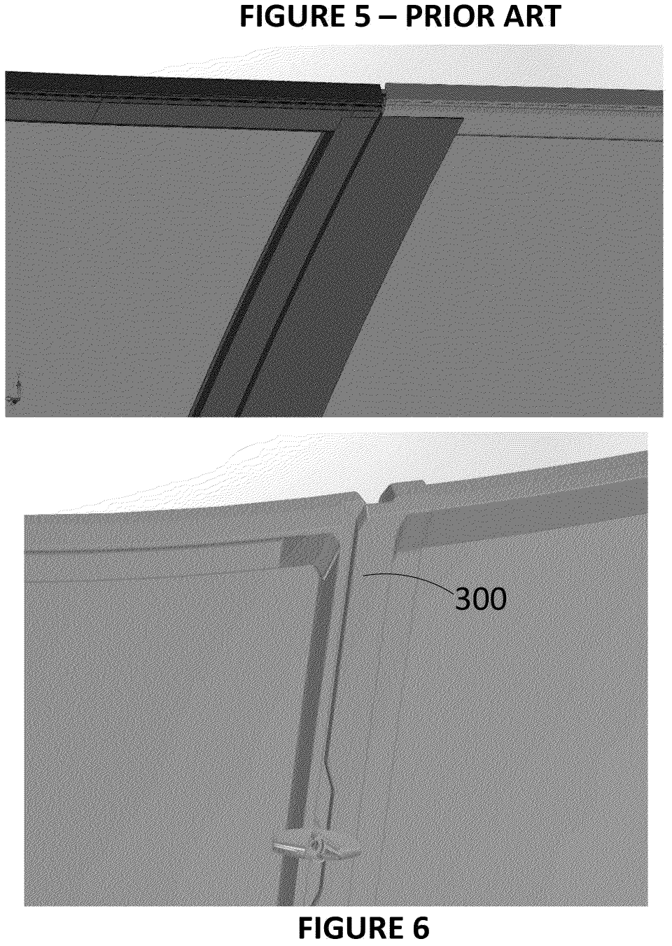

Referring now to FIG. 6, it is shown that the framing system according to an embodiment can exhibit greater variability or freedom of design and extended set of functionalities by providing encapsulation into the sub-assembly, e.g., the door would be encapsulated into the sub-frame system. The advantages appear in comparison with the prior-art equivalent shown in FIG. 5.

Encapsulation is particularly advantageous, as is the securement of the piece of glass with a dedicated sub-frame into a sub-frame assembly, because the sub-frame assembly can be easily handled and can be molded or cast to include parts which facilitate mounting into the boat to form the boat windshield.

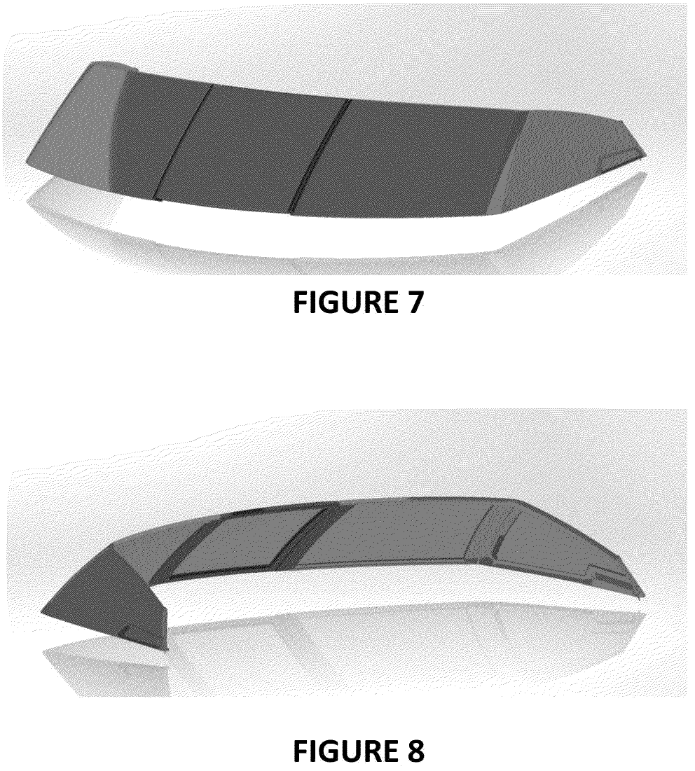

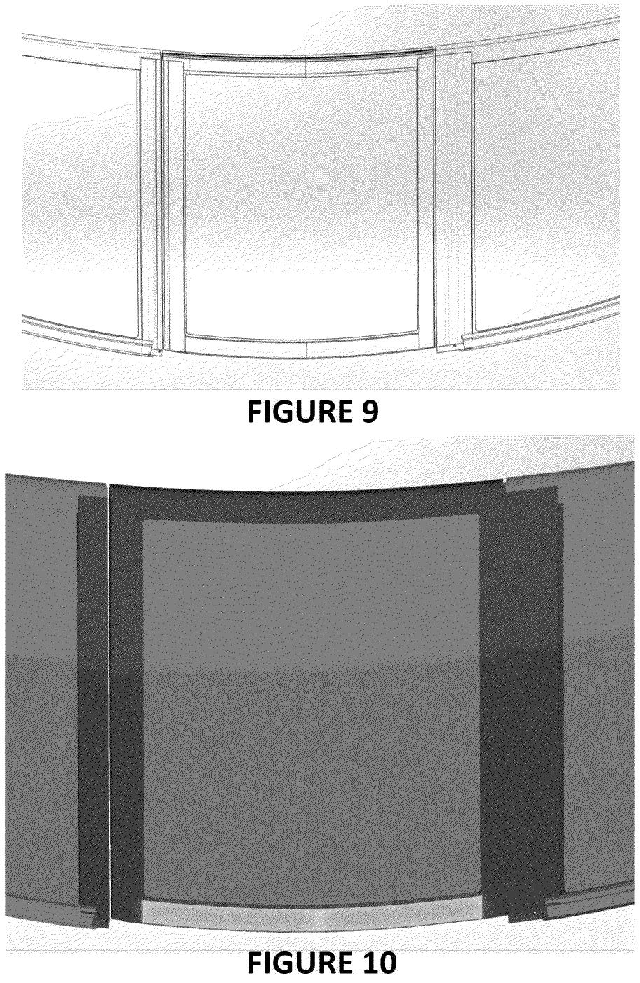

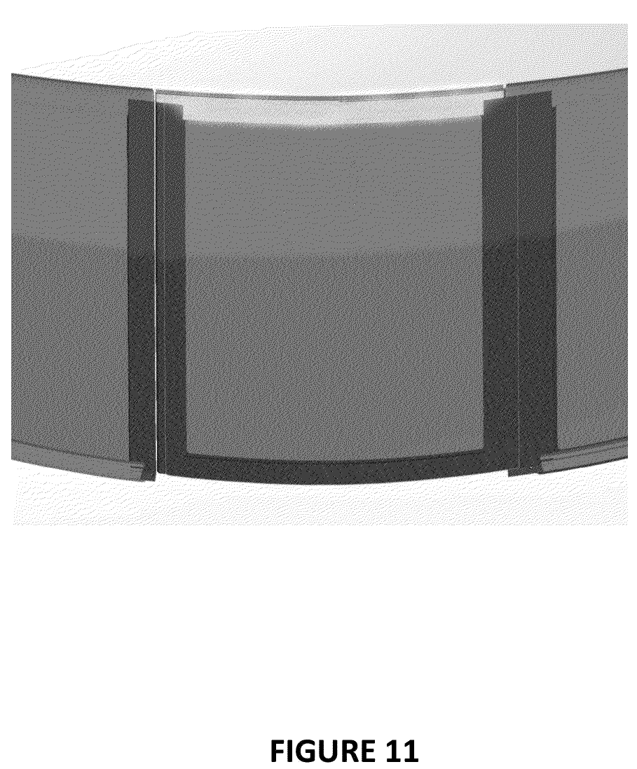

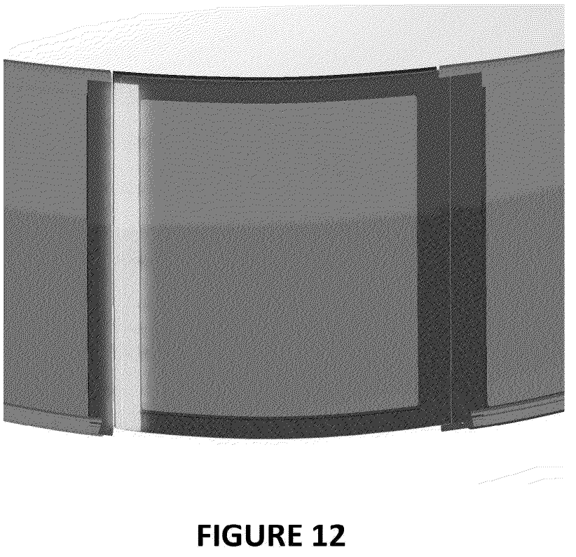

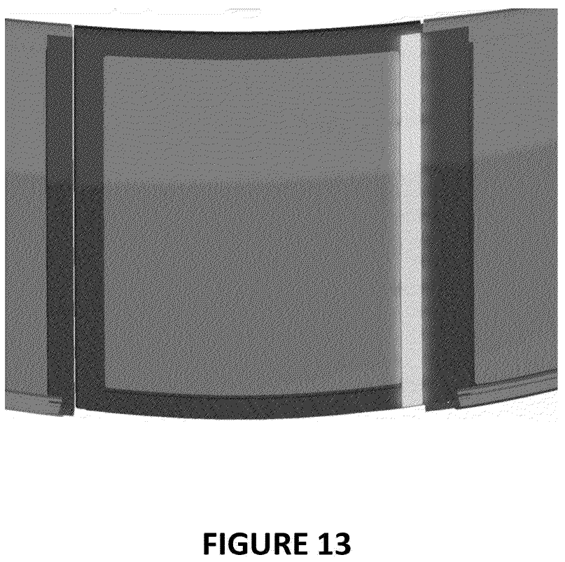

Now referring to FIGS. 7-13, FIGS. 7-8 are front perspective views illustrating a boat windshield with the molded or cast frame portions, according to an embodiment. More specifically, FIG. 9 is a rear view illustrating (with transparency) a door of a boat windshield with the molded or cast frame portions, with bottom, up, port and starboard portions highlighted, respect in FIGS. 10-13. In the prior art, such portions would each be made of an extrusion, of a purely linear shape with constant width along the length thereof, assembled together. According to an embodiment, such portions can be molded with a much more specific shape, and the frame can be molded with all such portions altogether, in an integral frame (i.e., a single piece comprising all these portions and molded integrally at once without any separation).

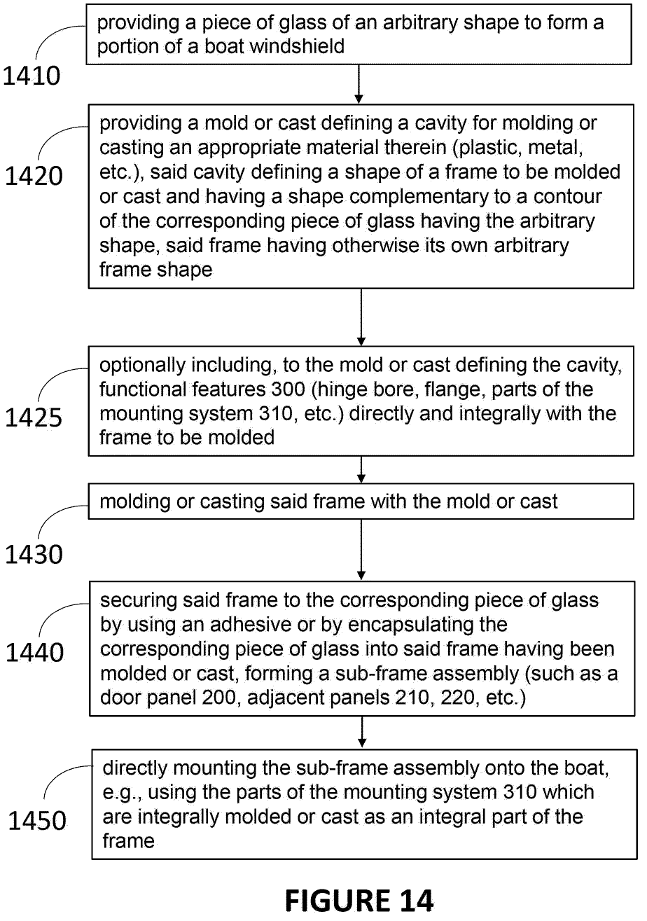

FIG. 14 is a flowchart which shows a method for manufacturing a boat windshield, according to an embodiment.

Step 1410: providing a piece of glass of an arbitrary shape to form a portion of a boat windshield.

Step 1420: providing a mold or cast defining a cavity for molding or casting an appropriate material therein (plastic, metal, etc.), said cavity defining a shape of a frame to be molded or cast and having a shape complementary to a contour of the corresponding piece of glass having the arbitrary shape, said frame having otherwise its own arbitrary frame shape.

Step 1425: optionally including, to the mold or cast defining the cavity, functional features 300 (hinge bore, flange, parts of the mounting system 310, etc.) directly and integrally with the frame to be molded.

Step 1430: molding or casting said frame with the mold or cast.

Step 1440: securing said frame to the corresponding piece of glass by using an adhesive or by encapsulating the corresponding piece of glass into said frame having been molded or cast, forming a sub-frame assembly (such as a door panel 200, adjacent panels 210, 220, etc.).

Step 1450: directly mounting the sub-frame assembly onto the boat, e.g., using the parts of the mounting system 310 which are protrusions with screw holes or the like and which are integrally molded or cast as an integral part of the frame.

Advantageously, the frame is exempt of any extruded part (only molded or cast parts). Extruded parts are formed by extrusion, by pressuring a material through an opening of a specific shape (cross-section) which results in an elongated extruded part of a constant cross-section (shape and dimensions) along a length thereof. The frame according to an embodiment of the present disclosure do not comprise any extruded part.

This method allows improving manufacturing repeatability when mounting the windshields on board. Also, the assembly is made much faster, which is less prone to mistakes and also ensures lower assembly costs.

According to an embodiment, the method also allows molding or casting into any suitable or desirable shape which can be molded or cast, with arbitrary curvatures such as a progressive curvature, without being constrained or limited to purely linear shapes as in the case of extrusions found in the prior art. Indeed, extruded parts have a constant width along their length, but molding or casting allows using a mold or cast which varies the width of a frame portion along the length thereof (i.e., varying width), and if this variation is not linear, it can imply that the frame portion is curved along the length thereof (i.e., curvatures). This possibility means that frame portions in specific windshield locations can be made thinner to improve visibility at these locations (less metal or plastic means more unobstructed glass being in the field-of-view of the people in the boat).

More generally, forming a part having an arbitrary shape would especially include forming a part having a shape departing from the typical shape of an extruded part or from a plate. Therefore, forming a part having an arbitrary shape according to an embodiment of the present embodiment includes forming a part having at least one of, and preferably more than one of: a varying cross-section along the length of the part, a varying width and depth over a length of the part; a longitudinal axis which is locally curved over a length of the part (especially for elongated parts); a portion (such as one of the functional features) which extends away from a main plane of the part (in the case of generally planar parts),

i.e., out from the main plane with which this portion would be integral. Examples can include a plate extending in a two-dimensional plane with a protrusion extending perpendicularly away in the other dimension while being integral with the plate; or an elongated object extending along a longitudinal axis with a protrusion extending perpendicularly from the longitudinal axis while being integral with the elongated object. Also, the object in these example can be more complex while being locally mostly planar or mostly elongated, plus the perpendicular protrusion forming the feature integral with a remainder of the frame being formed.

Forming parts using extrusion techniques or the like does not allows achieving such a result, and the embodiments of the present disclosure are clear that the frame or other parts are formed integrally as a single-piece without resorting to welding or soldering to avoid the downsides associated thereto. These characteristics apply to the part to be formed as well as to the tooling to form it, which should be consistent with the desired shape and dimensions (e.g., the mold should be complementary to the desired shape).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for manufacturing a boat windshield comprising the steps of:
providing a piece of glass of an arbitrary shape to form a portion of a boat windshield;
providing a mold or cast defining a cavity for molding or casting an appropriate material therein, said cavity defining a shape of a frame to be molded or cast and having a shape complementary to a contour of the corresponding piece of glass having the arbitrary shape, said frame having otherwise an arbitrary frame shape;
molding or casting said frame with the mold or cast; and
securing said frame to the corresponding piece of glass by using an adhesive or by encapsulating the corresponding piece of glass into said frame having been molded or cast, forming a sub-frame assembly being a panel of the boat windshield.

2. The method of claim 1, comprising including, to the mold or cast defining the cavity, functional features directly and integrally with the frame to be molded.

3. The method of claim 2, wherein including, to the mold or cast defining the cavity, functional features directly and integrally with the frame to be molded comprises, when forming a frame extending at least locally in a plane or an elongation axis and, forming the functional feature as a protrusion which extends away from the plane or the elongation axis of the frame.

4. The method of claim 3, wherein the protrusion is a flange integral with the frame for mounting the frame onto a boat.

5. The method of claim 3, wherein the functional features included directly and integrally with the frame to be molded comprise parts of a mounting system, the method further comprising:
directly mounting the sub-frame assembly onto a boat using the parts of the mounting system which are integrally molded or cast as an integral part of the frame of the sub-frame assembly.

6. The method of claim 5, wherein forming the functional features comprises forming a bore integral with a remainder of the frame at the time of forming the frame.

7. The method of claim 2, wherein including, to the mold or cast defining the cavity, functional features directly and integrally with the frame to be molded, comprises forming said functional features together with the frame being formed without altering the frame after the frame is formed to form said functional features.

8. The method of claim 2, wherein the frame and the functional features are formed together only by molding or casting.

9. The method of claim 1, wherein the frame is formed only by molding or casting.

10. The method of claim 1, wherein molding or casting said frame comprises forming the frame having at least a part thereof extending longitudinally along a length thereof, a cross-section being variable in at least one of shape and size along the length thereof.

11. The method of claim 1, wherein molding or casting said frame comprises forming the frame having at least a part thereof extending longitudinally along a longitudinal axis which is curved along a length thereof.

12. The method of claim 1, wherein molding or casting said frame comprises forming the frame having at least a part thereof extending along a plane, a thickness being variable along the plane.

13. The method of claim 1, wherein molding or casting said frame comprises forming the frame having at least a part thereof extending longitudinally along a length thereof, a cross-section being variable in at least one of shape and size along the length thereof.

14. A sub-frame assembly made by the method of claim 1.

15. A boat windshield made by the method of claim 5.

16. A method for manufacturing a boat windshield comprising the steps of:
providing a piece of glass of an arbitrary shape to form a portion of a boat windshield;
3D-printing a frame having a shape complementary to a contour of the corresponding piece of glass having the arbitrary shape, said frame having otherwise an arbitrary frame shape;
securing said frame to the corresponding piece of glass by using an adhesive or by encapsulating the corresponding piece of glass into said frame having been 3D-printed, forming a sub-frame assembly being a panel of the boat windshield.

17. The method of claim 16, wherein 3D-printing the frame comprises 3D-printing functional features directly and integrally with the frame being 3D-printed.

18. The method of claim 17, wherein the frame and the functional features are formed together only by 3D-printing.

19. The method of claim 18, wherein 3D-printing functional features directly and integrally with the frame being 3D-printed comprises, when forming a frame extending at least locally in a plane or an elongation axis and, forming the functional feature as a protrusion which extends away from the plane or the elongation axis of the frame.

20. The method of claim 18, wherein the functional features included directly and integrally with the frame comprise parts of a mounting system, the method further comprising:
directly mounting the sub-frame assembly onto a boat using the parts of the mounting system which are integrally 3D-printed as an integral part of the frame of the sub-frame assembly.
